(19) United States
(12) Patent Application Publication
(10) Pub. No.: US 2009/0244626 A1
(43) Pub. Date: Oct. 1, 2009

(54) Print method for optimizing document size based on pages remaining

(75) Inventors: Antonio Mangiacotti, Rome (IT); Milko Vaccaro, Rome (IT)

Correspondence Address: ZILKA-KOTAB, PC- IBMS, P.O. BOX 721120, SAN JOSE, CA, 95172-1120, US

(73) Assignee: International Business Machines Corporation, Armonk, NY (US)

(21) Appl. No.: 12/146,116

(22) Filed: Jun. 25, 2008

Related U.S. Application Data
(63) Continuation of application No. 12/060,083, filed on Mar. 31, 2008.

(51) Int. Cl. G06K 1/00

(52) U.S. Cl. 358/1.18

(57) ABSTRACT

A method includes receiving a print request, the print request including a number of pages to be printed; determining an approximate number of sheets of paper in a printer cache; if the number of pages to be printed is greater than the approximate number of sheets of paper in the printer cache, determining whether the print request indicates that page reduction is allowed; if page reduction is allowed, shrinking the pages to be printed for printing multiple pages on each sheet such that all pages will be printed on the available number of sheets of paper in the printer cache; and if page reduction is not allowed, not shrinking the pages.

### RELATED APPLICATIONS

This application is a continuation of U.S. patent applicaton Ser. No. 12/060,083 filed on Mar. 31, 2008, and which is herein incorporated by reference.

### BACKGROUND OF THE INVENTION

The present invention relates to data storage systems, and more particularly, this invention relates to printing and managing print queues.

A printer has a limited amount of pages that it can store in cache. This number varies depending on the type of printer. When a printer is sent a print request, it will print out pages according to the specifics of the print request, regardless of the number of sheets left in cache. If the number of sheets of paper in the printer cache is completely depleted before a print request is finished, the printer will pause the printing and wait for acknowledgment that more sheets of paper have been added to the printer cache.

This pausing of the printer will cause all print requests that have been sent to the printer to be blocked until more sheets of paper are added to the printer cache. The more often that print requests are sent to a printer, the more often this blockage will occur, and delay or halt printing operations. Some print requests are more important than others, and for many less important print requests, something less than a 1-1 sheet to page ratio would be acceptable.

### SUMMARY OF THE INVENTION

A method comprises receiving a print request, the print request including a number of pages to be printed; determining an approximate number of sheets of paper in a printer cache; if the number of pages to be printed is greater than the approximate number of sheets of paper in the printer cache, determining whether the print request indicates that page reduction is allowed; if page reduction is allowed, shrinking the pages to be printed for printing multiple pages on each sheet such that all pages will be printed on the available number of sheets of paper in the printer cache; and if page reduction is not allowed, not shrinking the pages.

Any of these embodiments may be implemented in a printer or printer system, which may include a network of printers.

Other aspects, advantages and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a simplified drawing showing four page reduction techniques that may be implemented according to several embodiments.

FIG. 2 shows a flow chart of a method according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of printers and printer systems, as well as operation and/or component parts thereof.

This specification includes the terms page(s) and sheet(s). For purposes of this specification, sheet or sheets refers to the pieces of paper that reside in a printer cache. Page or pages refers to the number of sheets that a print request would need to completely print a document sent to a printer. Normally, one page is printed per sheet when print reduction is not allowed. Print reduction allows a printer to print more than one page per sheet, resulting in a reduction of sheets required for a print request.

Also, this specification refers to a draft, which can be considered a copy of a document or work product which is not a final product, and is intended to be printed for review or some other intermediate step before it should be printed on a 1:1 page to sheet ratio. Some work product may not need to be printed on a 1:1 page to sheet ratio, and draft optimization can be selected for these types of works even when a final product is being printed.

In one general embodiment, a method comprises receiving a print request, the print request including a number of pages to be printed; determining an approximate number of sheets of paper in a printer cache; if the number of pages to be printed is greater than the approximate number of sheets of paper in the printer cache, determining whether the print request indicates that page reduction is allowed; if page reduction is allowed; shrinking the pages to be printed for printing multiple pages on each sheet such that all pages will be printed on the available number of sheets of paper in the printer cache; and if page reduction is not allowed, not shrinking the pages.

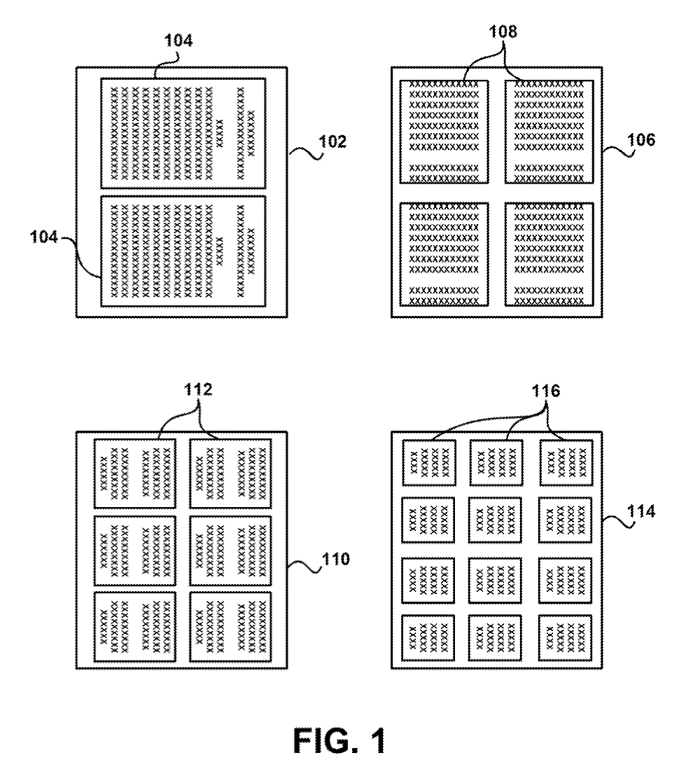

FIG. 1 is a simplified drawing showing the number of pages that can be printed pet sheet according to several embodiments. Sheet 102 is an example of reducing the number of sheets required to perform a print request by 50%, resulting in two pages 104 being printed per sheet 102. Each page 104 may be printed sideways as shown in FIG. 1, or can be printed facing upright in line with sheet 102.

Still referring to FIG. 1, sheet 106 is an example of reducing the number of sheets required to perform a print request by 75%, resulting in four pages 108 being printed per sheet 106. Each page 108 may be printed upright in line with sheet 106 as shown in FIG. 1, or can be printed sideways.

Sheet 110 is an example of reducing the number of sheets required to perform a print request by about 83%, resulting in six pages 112 being printed per sheet 108. Each page 112 may be printed sideways as shown in FIG. 1, or can be printed upright in line with sheet 106.

Sheet 114 is an example of reducing the number of sheets required to perform a print request by about 92%, resulting in twelve pages 116 being printed per sheet 114. Each page 116 may be printed sideways as shown in FIG. 1, or can be printed upright in line with sheet 114.

FIG. 1 shows several different embodiments of the page reduction techniques, but this does not in any way limit the different page reduction possibilities. Any ratio of greater than 1:1 page to sheet can be employed to optimize draft printing in accordance with this embodiment.

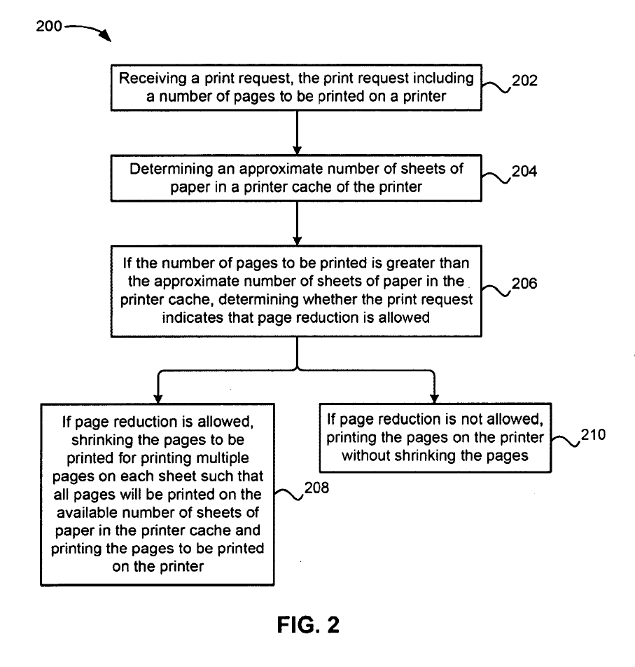

FIG. 2 illustrates a method 200 according to one embodiment. As an option, the present method 200 may be implemented in the context of functionality and architecture of FIG. 1. Of course, the method 200 may be carried out in any desired environment. It should be noted that the aforementioned definitions may apply during the present description.

With continued reference to FIG. 2, in operation 202, a print request is received, the print request including a number of pages to be printed.

In operation 204, an approximate number of sheets of paper in a printer cache is determined. This approximate number of sheets may be determined by weight of the sheets of paper in the printer cache, by stack height of the paper in the printer cache, or any other method which may approximate the number of sheets in the printer cache.

In operation 206, if the number of pages to be printed is greater than the approximate number of sheets of paper in the printer cache, then whether the print request indicates that page reduction is allowed is determined.

In operation 208, if page reduction is allowed, the pages to be printed for printing multiple pages on each sheet of paper are shrunk such that all pages will be printed on the available number of sheets of paper in the printer cache. The user who sent the print request may select whether the number of pages used during the printing of the print request may be reduced or not. Also, this page reduction may automatically be selected if the type of print request is specified by the user, such as designating the print request as a draft. This selection may be through the print function on a computer, or through an interface on the printer itself, or any other method of inputting to the printer that the print request allows page reduction.

In operation 210, if page reduction is not allowed as specified by the print request, the pages to be printed are not shrunk. In operation 210, printing will continue normally without any page reduction and the printer will pause printing when the sheets in the printer cache are completely depleted.

The advantages of allowing a printer to print more pages per sheet when print reduction is allowed are numerous. For example, if a printer has only 80 pages in the printer cache, and a print request requires 100 pages on a 1:1 page to sheet ratio but page reduction is selected at 25%, then the printer can print the request with only 20 pages. This saves 60 pages In the printer cache that can be used by another print request resulting in savings on paper, time, and support required for each printer. If the print request were allowed to print on a 1:1 page to sheet ratio, then another 20 pages would have to be added to the printer before the print request could be completed and the printer would be freed up to perform another print request. Someone would have to put more paper into the printer, and the printer would not be available for another print request until this was performed.

It will also be clear to one skilled in the art that the method of the present invention may suitably be embodied in a logic apparatus comprising logic to perform various steps of the methodology presented herein, and that such logic may comprise hardware components or firmware components.

It will be equally clear to one skilled in the art that the logic arrangement in various approaches may suitably be embodied in a logic apparatus comprising logic to perform various steps of the method, and that such logic may comprise components such as logic gates in, for example, a programmable logic array. Such a logic arrangement may further be embodied in enabling means or components for temporarily or permanently establishing logical structures in such an array using, for example, a virtual hardware descriptor language, which may be stored using fixed or transmittable carrier media.

It will be appreciated that the methodology described above may also suitably be carried out fully or partially in software running on one or more processors (not shown), and that the software may be provided as a computer program element carried on any suitable data carrier (also not shown) such as a magnetic or optical computer disc. The channels for the transmission of data likewise may include storage media of all descriptions as well as signal carrying media, such as wired or wireless signal media.

Embodiments of the present invention may suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

Communications components such as input/output or I/O devices (including but not limited to keyboards, displays, pointing devices, etc.) can be coupled to the system either directly or through intervening I/O controllers.

Communications components such as buses, interfaces, network adapters, etc. may also be coupled to the system to enable the data processing system, e.g., host, to become coupled to other data processing systems or remote printers or storage devices through intervening private or public networks. Modems, cable modem and Ethernet cards are just a few of the currently available types of network adapters.

It will be further appreciated that embodiments of the present invention may be provided in the form of a service deployed on behalf of a customer to offer service on demand.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A method, comprising:
receiving a print request, the print request including a number of pages to be printed on a printer;
determining an approximate number of sheets of paper in a printer cache of the printer;
if the number of pages to be printed is greater than the approximate number of sheets of paper in the printer cache, determining whether the print request indicates that page reduction is allowed;
if page reduction is allowed, shrinking the pages to be printed for printing multiple pages on each sheet such that all pages will be printed on the available number of sheets of paper in the printer cache and printing the pages to be printed on the printer; and
if page reduction is not allowed, printing the pages on the printer without shrinking the pages.
